(19) United States
(12) Patent Application Publication
(10) Pub. No.: US 2004/0073902 A1
(43) Pub. Date: Apr. 15, 2004

(54) Firmware upgrade method for network device through digital subscriber line

(75) Inventors: Chien-Chung Kao, Hsinchu (TW); Ming-Chieh Chen, Hsinchu (TW); Shu-Ken Lin, Hsinchu (TW)

Correspondence Address: QUINTERO LAW OFFICE, 1617 BROADWAY, 3RD FLOOR, SANTA MONICA, CA, 90404, US

(73) Assignee: Ambit Microsystems Corporation

(21) Appl. No.: 10/638,784

(22) Filed: Aug. 11, 2003

(30) Foreign Application Priority Data
Oct. 11, 2002 (TW) 91123487

(51) Int. Cl. G06F 9/44; G06F 9/445

(52) U.S. Cl. 717/171; 717/176

(57) ABSTRACT

A firmware upgrade method for a network device through a digital subscriber line. First, the network device transmits a request to a dynamic host configuration protocol server through a digital subscriber line. Then, information comprising a file server address and a query message are transmitted from the dynamic host configuration protocol server through the digital subscriber line to the network device in response to the request. The network device determines whether to upgrade the firmware of the network device according to the answer of the query message. If the network device determines to upgrade the firmware thereof, updated information about the firmware is downloaded from a file server corresponding to the file server address. Finally, the firmware of the digital subscriber line device is upgraded according to the updated information.

### BACKGROUND OF THE INVENTION

1. Field of the Invention

The invention relates to an application for a digital subscriber line device, and in particular, to a method for upgrading the firmware embedded in a network device through a digital subscriber line.

2. Description of the Related Art

Digital Subscriber Line technology architectures, generally denoted as xDSL, allow digital distribution of data services with traditional narrowband voice transmissions, such as a very high data rate digital subscriber line (VDSL), a packet-based transmission architecture used to provide high bandwidth distribution of digital video and data signals to customers, and an asymmetric digital subscriber line (ADSL).

A typical VDSL distribution system is similar to the typical ADSL distribution system. At a user end, it requires a network modem to connect to the VDSL network. The service provider who provides VDSL or ADSL service to the customers also provides a firmware upgrade service for the network modem at the user end. After the network modem is connected to a predetermined file server, updated information about the firmware can be downloaded thereby. Then, the user must use specified software to upgrade the firmware of the network modem. Downloading updated information about the device firmware to a network modem and upgrading the firmware of the network modem manually present considerable inconvenience.

### SUMMARY OF THE INVENTION

An object of the present invention is to provide a firmware upgrade method for a network device through a digital subscriber line. The firmware upgrade method of the present invention is achieved by automatically downloading updated information about the device firmware to a network modem and upgrading the firmware of the network modem by a dynamic host configuration protocol (DHCP) server without the intervention of manpower, which in turn increases convenience.

Accordingly, the present invention provides a firmware upgrade method for a network device through a digital subscriber line. First, the network device transmits a request to a dynamic host configuration protocol (DHCP) server through a digital subscriber line. Then, a file server address and a query message are transmitted from the dynamic host configuration protocol server through the digital subscriber line to the network device in response to the request. The network device determines whether to upgrade the firmware embedded therein according to the answer of the query message. If the network device determines to upgrade the firmware, updated information about the firmware is downloaded from a file server sited on the file server address. Finally, the firmware of the network device is upgraded according to the updated information.

Furthermore, the present invention also provides another firmware upgrade method for a network device through a digital subscriber line. First, the network device transmits a request to a dynamic host configuration protocol server through a digital subscriber line. Then, a file server address is transmitted from the dynamic host configuration protocol server through the digital subscriber line to the network device in response to the request. Next, the network device transmits a request to a file server sited on the file server address to obtain a query message. According to the answer of the query message, the network device determines whether to upgrade the firmware embedded therein. If the network device determines to upgrade the firmware, updated information about the firmware is downloaded from the file server. Finally, the firmware of the network device is upgraded according to the updated information.

### DESCRIPTION OF THE DRAWINGS

For a better understanding of the present invention, reference is made to a detailed description to be read in conjunction with the accompanying drawings, in which:

FIG. 1 is a flowchart illustrating a firmware upgrade method for a network device through a digital subscriber line according to the first embodiment of the invention;

FIG. 2 is a flowchart illustrating a firmware upgrade method for a network device through a digital subscriber line according to the second embodiment of the invention; and

FIG. 3a and FIG. 3b are flowcharts illustrating a firmware upgrade method for a network device through a digital subscriber line according to the third embodiment of the invention.

### DETAILED DESCRIPTION OF THE INVENTION

The invention discloses a firmware upgrade method for a network device through a digital subscriber line. According to the invention, downloading firmware upgrade information to a network device and upgrading the firmware of the network device automatically and quietly can facilitate the users of the network device connected to a digital subscriber line. The firmware upgrade method of the present invention can be used in all kinds of digital subscriber line devices such as very high data rate digital subscriber line (VDSL) and asymmetric digital subscriber line (ADSL) modems.

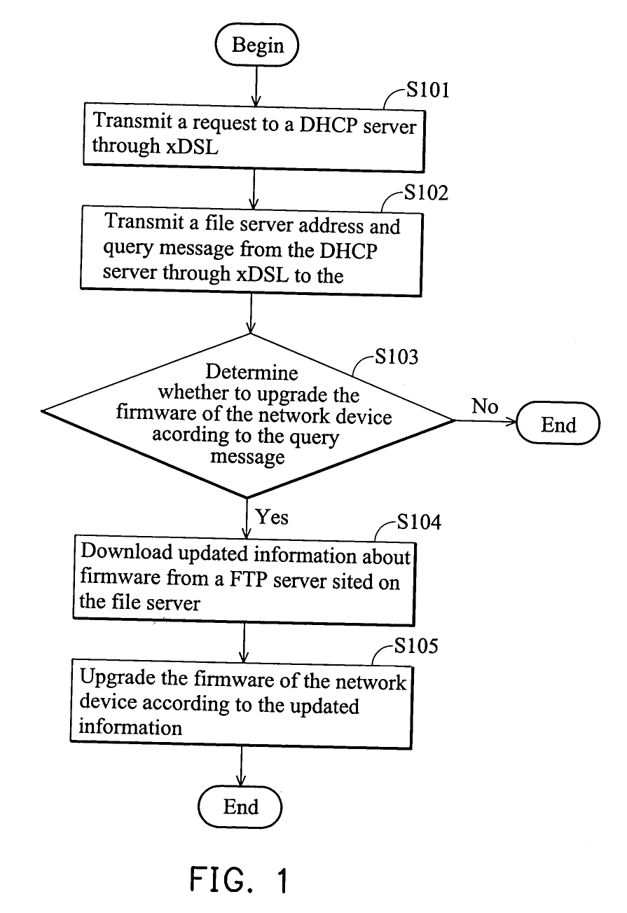

FIG. 1 is a flowchart illustrating a firmware upgrade method for a network device according to the first embodiment of the present invention. First, a network device transmits a request to a dynamic host configuration protocol (DHCP) server through a digital subscriber line (S101). The step starts if the network device first queries the server for an IP address or every time the modem requests the server to renew the leased IP address. Then, a file server address and a query message are transmitted from the dynamic host configuration protocol server through the digital subscriber line to the ADSL modem in response to the request (S102). The query message comprises a serial number representing the firmware version and a hardware identification number. The serial number of the firmware version determines whether the firmware of the network device requires to be upgraded with the updated information. The hardware identification number determines whether the ADSL modem conforms to a hardware requirement for the updated information. After receiving the file server address and the query message, the network device determines whether to upgrade the firmware according to the answer of the query message (S103). If the network device determines not to upgrade the firmware, the upgrade procedure is ended. If the network device determines to upgrade the firmware, updated information about the firmware is downloaded from a file transfer protocol (FTP) server sited on the file server address (S104). Finally, the firmware of the network device is upgraded according to the updated information (S105).

In this embodiment, the FTP sever is taken as an example to store the updated information about the firmware. The updated information may be stored in another kind of file server such as a trivial file transfer protocol (TFTP) server.

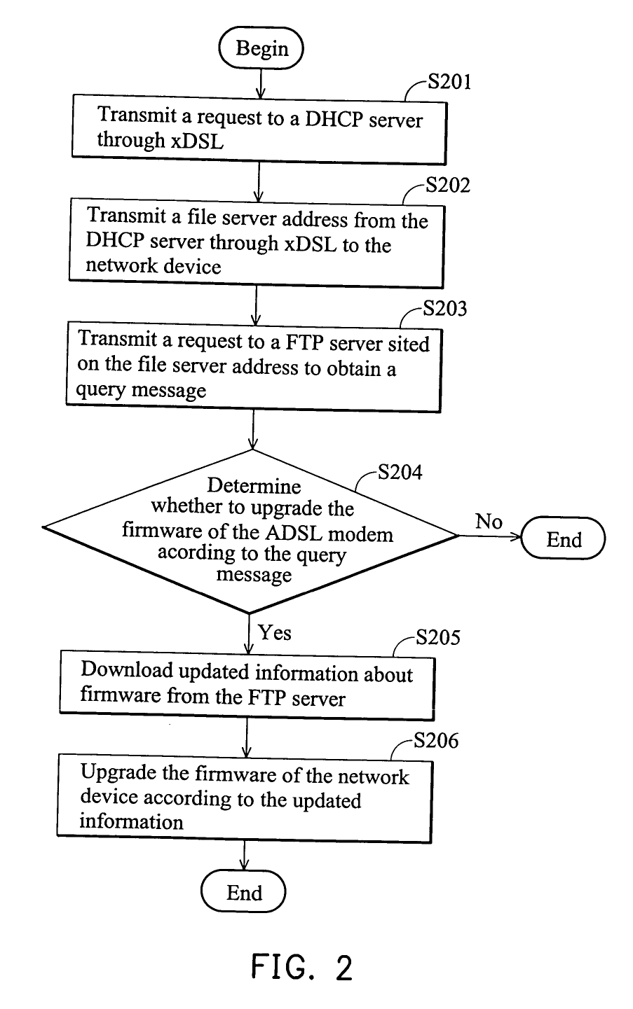

FIG. 2 is a flowchart illustrating a firmware upgrade method for a network device according to the second embodiment of the invention. First, the network device transmits a request to a dynamic host configuration protocol (DHCP) server through a digital subscriber line (S201). Then, a file server address is transmitted from the dynamic host configuration protocol server to the network device in response to the request (S202). Next, the network device transmits a request to a file transfer protocol (FTP) server sited on the received file server address to obtain a query message therefrom (S203). The query message comprises an identification number representing a firmware version number and an identification number of hardware. The identification number of the firmware version determines whether the firmware of the network device is required to be upgraded with updated information. The identification number of hardware determines whether the network device conforms to a hardware requirement for the updated information. After receiving the query message, the network device determines whether to upgrade the device firmware according to the answer of the query message (S204). If the network device determines not to upgrade the firmware, the upgrade procedure is ended. If the ADSL modem determines to upgrade the firmware, updated information about the firmware is downloaded from the FTP server (S205). Finally, the firmware of the ADSL modem is upgraded according to the updated information (S206).

In this embodiment, the FTP sever is taken as an example to store the updated information about the firmware. The updated information may be stored in another kind of file server such as a trivial file transfer protocol (TFTP) server.

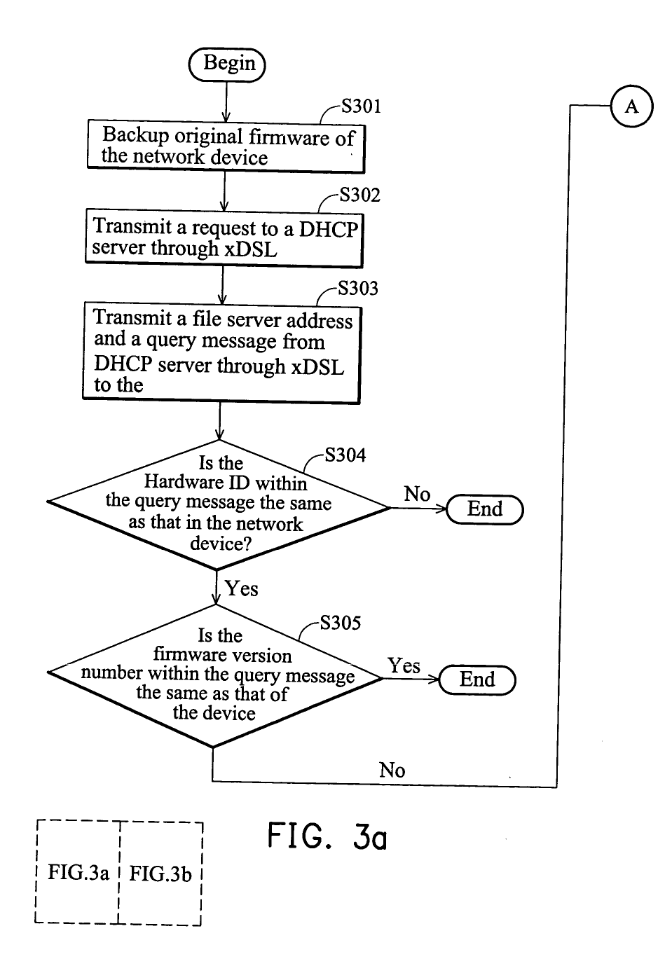

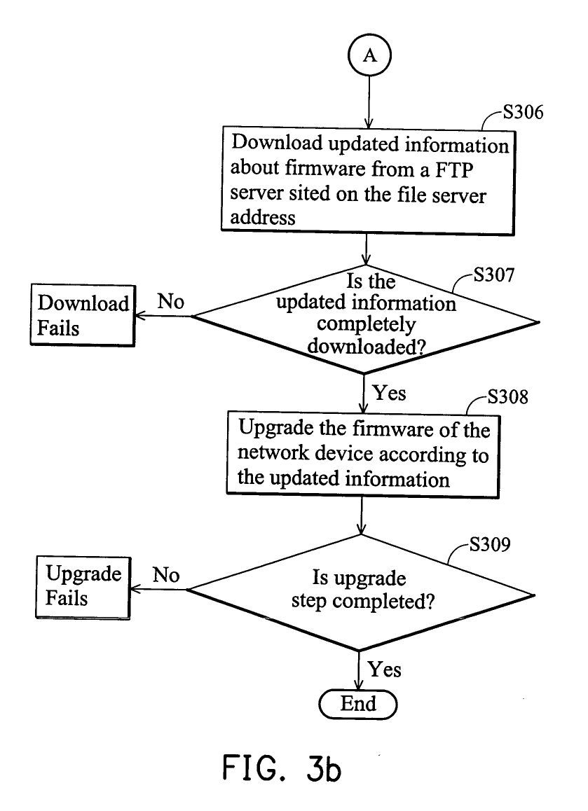

FIG. 3a and FIG. 3b are flowcharts illustrating a firmware upgrade method for a network device according to the third embodiment of the invention. During the upgrade procedure, unexpected events such as power interruption or Internet disconnect may cause download of incompletely updated information or incompletely written upgrade information, such that the network device cannot start normally. To avoid this, in the third embodiment of the present invention, a flash memory storing the firmware of the network device is divided into two storage areas. One of the storage areas stores the original firmware and cannot be rewritten by the updated information. The updated information used to upgrade the firmware device is written into the other storage area storing a replica of the firmware of the network device. Thus, during the upgrade procedure, the backup firmware ensures the normal operation of the network device. As shown in FIG. 3, before the upgrade procedure starts, the network device backups the original firmware (S301) in a write-protected storage area of the network device.

Then, the network device transmits a request to a dynamic host configuration protocol (DHCP) server (S302) through a digital subscriber line. The step starts if the network device first queries a server for an IP address or every time the network device requests the server to renew the leased IP address. Then, a file server address and a query message are transmitted from the dynamic host configuration protocol server through the digital subscriber line to the network device in response to the request (S303). The query message comprises an identification number representing a firmware version number and an identification number of hardware. The identification number of the firmware version determines whether the network device is required to be upgraded with the updated information. The identification number of hardware determines whether the network device conforms to a hardware requirement for the updated information. After receiving the file server address and the query message, the ADSL modem checks whether the identification number of hardware is the same as an identification number of hardware stored in the network device (S304). If they are different, the updated information is not compatible with the network device, and the procedure is ended. If they are the same, the ADSL modem checks whether the identification number of the firmware version is the same as an identification number of the firmware version in the network device (S305). If they are the same, the network device does not need to upgrade the firmware, and the procedure is ended. If they are different, updated information about the firmware is downloaded from a file transfer protocol (FTP) server sited on the file server address (S306). Then, the network device checks whether the updated information has been downloaded completely (S307). If the updated information has not been downloaded completely, the procedure fails and the network device uses the original firmware to start the next time operation. If the updated information has been downloaded completely, the firmware stored in the flash memory of the network device is upgraded according to the updated information (S308). Finally, the network device checks whether the upgrade step (the step S308) has been completed (S309). If the upgrade step has been completed, the network device uses the updated firmware to start the next time operation. If the upgrade step has not been completed, the upgrade procedure fails and the network device uses the original firmware backed up in the write-protected storage area to start the next time operation.

In this embodiment, the FTP sever is taken as an example to store the updated information about the firmware. The updated information may be stored in another file server such as trivial file transfer protocol (TFTP) server.

The firmware upgrade method for a network device through a digital subscriber line provided by the invention is distinct from the prior art by the downloading updated information about the firmware of the network device through a digital subscriber line and upgrading the firmware of the network device automatically by the dynamic host configuration protocol server. Thus, the convenience for users to upgrade the firmware of a network device is increased. For a network device, the present invention also provides a reliable method of upgrading firmware from a remote server automatically. Every time the network device queries a remote server to renew the same IP address, the digital subscriber line device obtains firmware of the last version.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A firmware upgrade method for a network device through a digital subscriber line comprising:
transmitting a request from the network device through a digital subscriber line to a dynamic host configuration protocol server;
transmitting a file server address and a query message from the dynamic host configuration protocol server through the digital subscriber line to the network device in response to the request;
determining whether to upgrade the firmware of the network device according to the answer of the query message;
if the network device determines to be upgraded with firmware, downloading updated information about the firmware from a file server sited on the file server address; and
upgrading the firmware of the network device according to the updated information.

2. The firmware upgrade method of claim 1, wherein the query message comprises:
an identification number of a firmware version for determining whether the network device requires to be upgraded with the updated information;
an identification number of hardware for determining whether the network device conforms to a hardware requirement for the updated information.

3. The firmware upgrade method of claim 1, wherein the network device is an asymmetric digital subscriber line (ADSL) modem.

4. The firmware upgrade method of claim 1, wherein the network device is a very-high data rate digital subscriber line (VDSL) modem.

5. The firmware upgrade method of claim 1, wherein the file server is a file transfer protocol (FTP) server.

6. The firmware upgrade method of claim 1, wherein the file server is a trivial file transfer protocol (TFTP) server.

7. A firmware upgrade method for a network device through a digital subscriber line comprising:
transmitting a request from the network device through a digital subscriber line to a dynamic host configuration protocol server;
transmitting a file server address from the dynamic host configuration protocol server through the digital subscriber line to the network device in response to the request;
transmitting a request from the network device to a file server sited on the file server address to obtain a query message;
determining whether to upgrade the firmware of the network device according to the answer of the query message;
if the network device determines to upgraded with the firmware, downloading updated information about the firmware from the file server; and
upgrading the firmware of the network device according to the updated information.

8. The firmware upgrade method of claim 7, wherein the query message comprises:
an identification number of a firmware version for determining whether the network device is required to be upgraded with the updated information;
an identification number of hardware for determining whether the network device conforms to a hardware requirement for the updated information.

9. The firmware upgrade method of claim 7, wherein the network device is an asymmetric digital subscriber line (ADSL) modem.

10. The firmware upgrade method of claim 7, wherein the network device is a very-high data rate digital subscriber line (VDSL) modem.

11. The firmware upgrade method of claim 7, wherein the file server is a file transfer protocol (FTP) server.

12. The firmware upgrade method of claim 7, wherein the file server is a trivial file transfer protocol (TFTP) server.
